(19) United States
(12) Patent Application Publication
(10) Pub. No.: US 2008/0145832 A1
(43) Pub. Date: Jun. 19, 2008

(54) Test Question Constructing Method and Apparatus, Test Sheet Fabricated Using the Method, and Computer-Readable Recording Medium Storing Test Question Constructing Program for Executing the Method

(76) Inventor: Jong Min Lee, Seoul (KR)

Correspondence Address: DICKSTEIN SHAPIRO LLP, 1825 EYE STREET NW, Washington, DC, 20006-5403, US

(21) Appl. No.: 11/795,807

(22) PCT Filed: Dec. 22, 2005
(86) PCT No.: PCT/KR2005/004445

§ 371 Date: Jul. 23, 2007

(30) Foreign Application Priority Data
Jan. 24, 2005 (KR) 10-2005-0006330

(51) Int. Cl. G09B 7/00

(52) U.S. Cl. 434/362

(57) ABSTRACT

The present invention relates to a test question constructing apparatus and method, a test sheet fabricated using the method, and a computer-readable recording medium storing a test question constructing program for executing the method. The test question constructing apparatus includes a reception unit, a first conversion unit, a database, a correct answer arrangement generating unit, and a second conversion unit. The receiving unit receives a plurality of questions and meta information, containing attributes thereof. The first conversion unit converts the received questions into data files, containing content and composition information. The database stores the meta information and the data files. The correct answer arrangement creation unit varies arrangement of respective choices for test questions using the data files and the meta information. The second conversion unit extracts a plurality of data files from the database and converts the data files into a format available for the test.

### TECHNICAL FIELD

The present invention relates, in general, to a test question constructing apparatus and method, a test sheet fabricated using the method, and a computer-readable recording medium storing a test question constructing program for executing the method and, more particularly, to a test question constructing apparatus and method, which can prevent cheating between a plurality of testees, a test sheet fabricated using the method, and a computer-readable recording medium storing a test question constructing program for executing the method.

### BACKGROUND ART

Generally, the types of tests can be classified into a multiple-choice type objective test of presenting a plurality of questions and several choices (answers) for each question and allowing the answer to a corresponding question to be selected from among the plurality of choices, a short answer type subjective test of presenting a question and allowing a simple answer to the corresponding question to be written, and an essay type subjective test of presenting a question and allowing a testee's opinion to be written as a long sentence in response to the presented question.

An essay type subjective test is advantageous in that the features and knowledge degree of a testee can be precisely determined, whereas it is problematic in that a lot of time is required for a marker to read and understand the answer of the testee and different scores may be given for the same answer due to the subjective opinion of the marker during a procedure of scoring the test.

A short type subjective test is characterized in that the influence of a marker's subjectivity is relatively low, unlike the essay type subjective test, and there are few cases where a testee luckily writes a correct answer without knowing the correct answer because the testee can write an answer only when he knows the correct answer. However, since a marker must personally consider each question and determine whether a correct answer is written, a lot of time is required to score the test.

Further, a multiple-choice type objective test is implemented to understand a question and select a single choice among several numbered choices presented along with the question (answers presented for a testee to select) unlike the essay type subjective test and the short answer type subjective test, and is characterized in that, if the number corresponding to the choice considered to be the correct answer by a testee is recorded on an Optical Mark Reader (OMR) card, etc., the recorded results can be scored using a computer, so that the time required for a process of scoring the test is greatly shortened, thus allowing the testee to know his or her score immediately after completing the test.

Recently, among such various types of tests, a multiple-choice type objective test has been generally adopted because a plurality of persons can simultaneously participate in a test and it is convenient to score the test.

### DISCLOSURE

### Technical Problem

However, due to the development of wireless communication technology, cheating between testees using mobile phones, etc. have occurred frequently. Accordingly, distinction between testees taking a multiple-choice type objective test has decreased and, in addition, testees who take the test in good faith, but who are harmed frequently appear, so that such cheating in a test has become recognized as a social issue.

Accordingly, the present invention has been made keeping in mind the above problems occurring in the prior art, and an object of the present invention is to provide a test question constructing apparatus and method, which can vary the pattern of test questions to prevent cheating between a plurality of testees, thus improving distinction between the testees, a test sheet fabricated using the method, and a computer-readable recording medium storing a test question constructing program for executing the method.

### Technical Solutions

In accordance with one aspect of the present invention to accomplish the above object, the present invention provides a test question constructing apparatus, comprising a receiving unit for receiving a plurality of questions and meta information, containing attributes thereof, through a network; a first conversion unit for converting the received questions into data files, containing content and composition information; a database for storing therein the meta information of the received questions and the data files; a correct answer arrangement generating unit for varying arrangement of respective answer choices for test questions to be equally provided to testees using the data files and the meta information stored in the database, depending on a preset degree of shuffling, thus creating different correct answer arrangements for respective testees; and a second conversion unit for extracting a plurality of data files stored in the database and converting the data files into a format available for a test so that test questions having different correct answer arrangements for respective testees are output, based on correct answer arrangement information generated by the correct answer arrangement generating unit.

In accordance with another aspect of the present invention to accomplish the above object, the present invention provides a test question constructing method, comprising a first step of receiving a plurality of questions and meta information, containing attributes thereof, through a network; a second step of converting the received questions into data files, containing content and composition information; a third step of storing the meta information of the received questions and the data files in a database; a fourth step of varying arrangement of respective answer choices for test questions to be equally provided to testees using the data files and the meta information stored in the database, depending on a preset degree of shuffling, thus creating different correct answer arrangements for respective testees; and a fifth step of extracting a plurality of data files stored in the database and converting the data files into a format available for a test so that test questions having different correct answer arrangements for respective testees are output, based on correct answer arrangement information generated at the fourth step.

### ADVANTAGEOUS EFFECTS

According to the present invention, the arrangement of correct answers is made different through the varied shuffling of choices when a plurality of testees simultaneously take a test, so that cheating between the testees occurring during the test are prevented, thus improving distinction between testees.

### DESCRIPTION OF DRAWINGS

FIG. 1 is a diagram showing the construction of a test question constructing apparatus according to the present invention;

FIG. 2 illustrates an example of a screen on which questions, input through the reception unit of FIG. 1, are edited using a general-purpose word processor program;

FIG. 3 is a diagram showing a source sample obtained after conversion has been performed by the Extensible Markup Language (XM) conversion unit of FIG. 1;

FIG. 4 illustrates an example of correct answer arrangement information stored in the database of FIG. 1;

FIG. 5 is a diagram showing the operation of the HyperText Markup Language (HTML) conversion unit of FIG. 1;

FIGS. 6 to 8 illustrate examples of a screen used to describe the embodiment of the present invention, which show screen examples in which the varied shuffling of answer choices is performed for the same question;

FIGS. 9 to 11 illustrate examples of a screen employed to describe the embodiment of the present invention, which show screen examples in which the varied shuffling of answer choices is performed for each question in the same subject;

FIG. 12 is a flowchart of a test question constructing method according to an embodiment of the present invention;

FIG. 13 is a flowchart showing the procedure of creating and storing correct answer arrangement information of FIG. 12 in detail;

FIG. 14 is a flowchart showing the procedure of constructing test questions based on the correct answer arrangement of FIG. 12 in detail; and

FIG. 15 illustrates an example of an OMR card applied to the embodiment of the present invention.

### BEST MODE

Hereinafter, a test question constructing apparatus and method according to embodiments of the present invention will be described in detail with reference to the accompanying drawings.

The test question constructing apparatus according to an embodiment of the present invention is a device for constructing test questions online and sending the constructed test questions online or offline to testees. That is, the test question constructing apparatus of the present invention is associated with online and offline service.

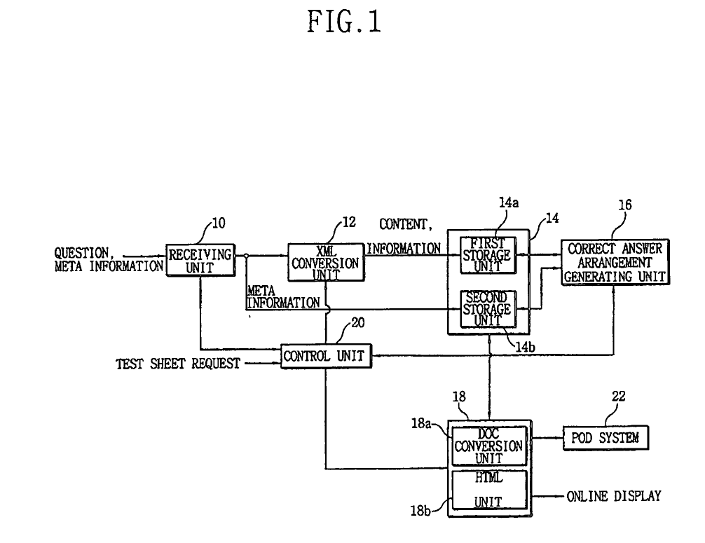

FIG. 1 is a diagram showing the construction of a test question constructing apparatus according to the present invention. The construction of FIG. 1 is provided in an operator server (that is, a server capable of receiving various questions and constructing test questions based on the received questions in the present invention, not shown) equipped with a Web server (not shown), a dedicated line (not shown), etc.

Referring to FIG. 1, the test question constructing apparatus of the present invention includes a receiving unit 10 for receiving a plurality of questions transmitted from a question master (for example, questions made by the question master using a general-purpose word processor program) and meta information, containing the attributes of each question, through a network (for example, the Internet); an Extensible Markup Language (XML) conversion unit 12, which is a first conversion unit for converting the received questions into data files (XML format), containing content and composition information; and a database 14 for storing meta information about each question received by the receiving unit 10 and the data files with respect to each subject.

Further, the test question constructing apparatus of the present invention includes a correct answer arrangement generating unit 16 for constructing a number of questions of each subject and answer choices thereof using the data files and the meta information stored in the database 14 and varying the arrangement of correct answers to the constructed questions depending on a predetermined degree of shuffling to allow respective testees to have different correct answer arrangements; the second conversion unit 18 for converting a plurality of data files into a format available for a test so that test questions having different correct answer arrangements for respective testees are output based on the correct answer arrangement information generated by the correct answer arrangement generating unit 16; and a control unit 20 for controlling the operation of the above units.

Further, the test question constructing apparatus of the present invention includes a data input means such as a keyboard, pen mouse or typical voice recognition software package, a display means such as a video monitor, a voice output means such as a speaker, and a processing means such as a Central Processing Unit (CPU), and also includes the terminal of a question master (not shown, for example, Personal Computer: PC) provided with a Web browser program and software and hardware for providing wired/wireless Internet communication functions.

In this case, the terminal of the question master is provided with a program enabling questions and meta information related to the construction of test questions to be input, in addition to a general-purpose word processor program (for example, Microsoft Word, etc.) (hereinafter referred to as a “word processor”).

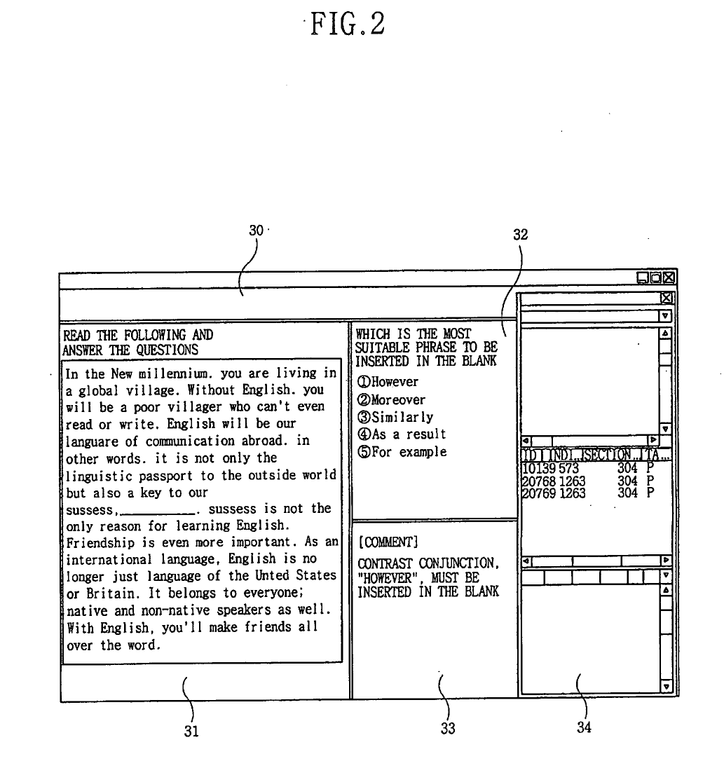

As shown in FIG. 2, on the monitor of the terminal of the question master, a screen, divided into an reference part 30 for allowing general advance information to be provided for questions, a passage part 31, a question input part 32, a comment part 33, and a meta information input part 34, is displayed.

Therefore, the question master need only input content suitable for each divided part when desiring to input questions. Meta information that is input to the meta information input part 34 is dependent on each question input to the question input part 32, and contains a correct answer to the question, information indicating whether answer choices concerning the question can be shuffled, the subject to which the question belongs, an identification (ID) of the question, etc.

If the question master selects “save” after inputting required questions and meta information thereof while viewing the screen of FIG. 2, the questions and meta information are transmitted from the terminal of the question master to the receiving unit 10 through a network, such as the internet, and are converted into XML format by the XML conversion unit 12. The XML conversion unit 12 generates a data file, for example, “sample.xml”, as a result of the conversion.

For reference, if the data file “sample.xml” is stored in a unicode encoding mode (for example, Universal Character Set [UCS] Transformation Format, 8-bit form: UTF-8) and then is opened in a word processor, the original document can be seen.

Content input to the reference part 30, the passage part 31, the question input part 32 and the comment part 33 is converted into XML format by the XML conversion unit 12 and is stored in the first storage unit 14a. The content can be freely composed using Extensible Style Language (XSL) or other conversion technologies.

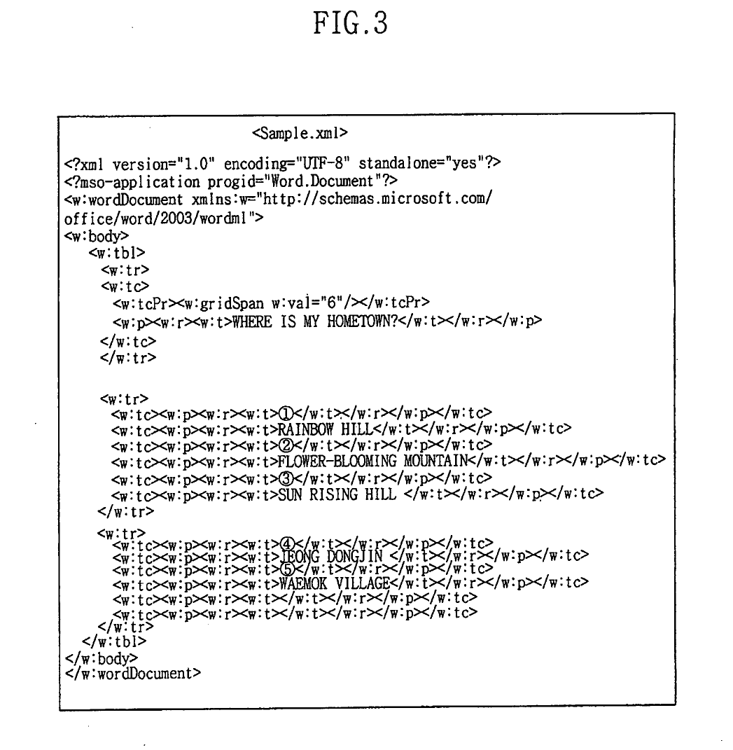

For reference, FIG. 3 illustrates an example of the content of the data file “sample.xml” output from the XML conversion unit 12.

The data file contains content and composition information. For example, the content of FIG. 3 may be “Where is my hometown?”, “\textcircled{1}”, “Rainbow Hill”, “\textcircled{2}”, “Flower-Blooming Mountain”, “\textcircled{3}”, “Sun rising Hill”, “\textcircled{4}”, “Jeong Dongin”, “\textcircled{5}”, “Waemok Village”, etc. For example, the composition information in FIG. 3 denotes information required to compose the above content, which means information other than the content (for example, spacing words, the sequence of answer choices, etc.).

The database 14 includes the first storage unit 14a for storing content and composition information contained in the data file (XML format), which is converted by and output from the XML conversion unit 12, and the second storage unit 14b for storing meta information dependent on a plurality of questions received by the receiving unit 10. Further, in the second storage unit 14b, correct answer arrangement information, which will be described later, is also stored.

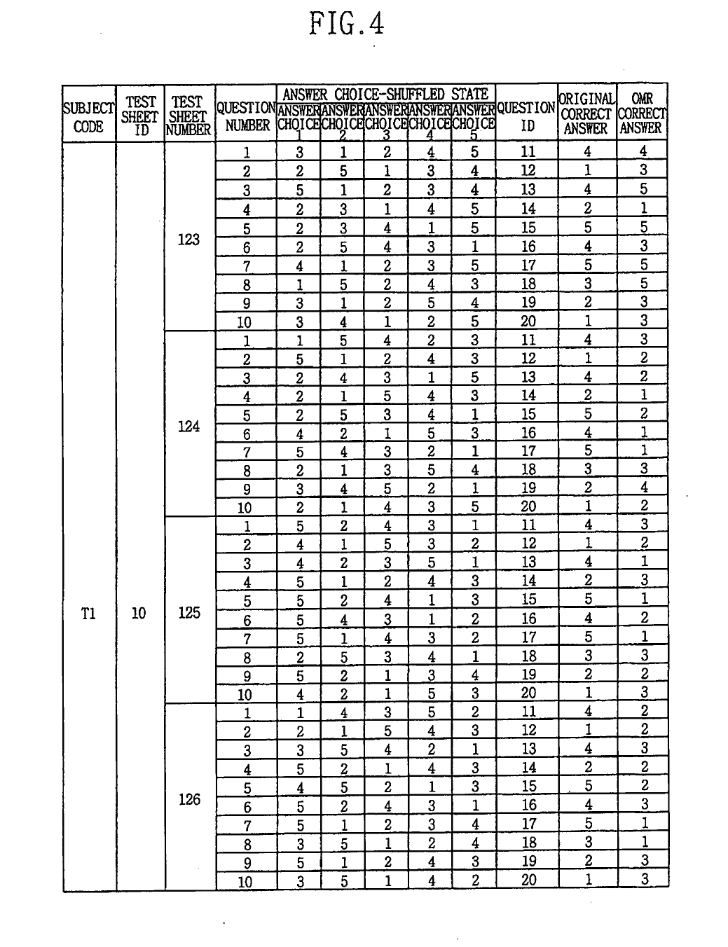

The correct answer arrangement information generated by the correct answer arrangement generating unit 16 includes a subject code, a test sheet identification (ID) belonging to the subject code, a test sheet number for each testee belonging to the test sheet ID, and correct answers to questions, in which answer choices have been differently shuffled for respective test sheet numbers. That is, it can be considered that correct answer arrangement information obtained by the correct answer arrangement generating unit 16 is configured as shown in FIG. 4.

FIG. 4 illustrates an example in which 10 questions are equally included for respective test sheet numbers 123, 124, 125, 126 and 127 having a test sheet ID of “10” with respect to a subject code of “T1”, and the arrangement of correct answers to respective questions is differently set for respective test sheet numbers.

In FIG. 4, only answer choices for each question are shuffled without changing the sequence of questions existing for respective test sheet numbers. If possible, the sequence of questions equally arranged for respective test sheet numbers can be changed. In FIG. 4, there are 5 test sheet numbers, the number of which is equal to the number of testees who have a test ID of “10” for a subject code of “T1” and take the test.

The degree of shuffling used in the correct answer arrangement generating unit 16 is set to 3 or above. For example, if answer choices for an original question are arranged in the sequence of A, B, C, D and E, and the arrangement sequence thereof is changed to the sequence of A, C, B, D and E, the degree of shuffling is 2. Therefore, a degree of shuffling of 3 or more means that the arrangement of 3 or more answer choices is changed compared to the arrangement of the answer choices for the original question.

Since an operator, operating the apparatus of the present invention, can select required test questions and the number of test questions for each subject at any time, the operator can predetermine test questions and the number of test questions for each subject or within the test range of each subject, and can preset the arrangement of original correct answers to the predetermined test questions.

The second conversion unit 18 includes a document (DOC) conversion unit 18a for converting the plurality of data files into respective documents for a word processor, and a Hypertext Markup Language (HTML) conversion unit 18b for converting the data files into respective HTML documents.

The documents for a word processor, output from the DOC conversion unit 18a, are transmitted to a Print-on-Demand (POD) system 22, and the HTML documents, output from the HTML conversion unit 18b, are displayed on the screen of the terminal of each testee through a web browser.

One of the DOC conversion unit 18a and the HTML conversion unit 18b of the second conversion unit 18 can be selectively operated, or both can be simultaneously operated according to circumstances. If test questions must be provided to the offline POD system 22 and test sheets must be printed, the test questions are ultimately provided to the POD system 22 through the DOC conversion unit 18a, whereas if an online member requests test questions, the test questions are ultimately transmitted to the corresponding member through the HTML conversion unit 18b.

The conversion of XML documents for a word processor, performed by the HTML conversion unit 18b through a procedure of processing a data file (XML)->XSL conversion->HTML document, can be viewed through the web browser. That is, sample.xml+xml_to_html.xsl=sample.html is processed, so that the conversion can be viewed through the web browser.

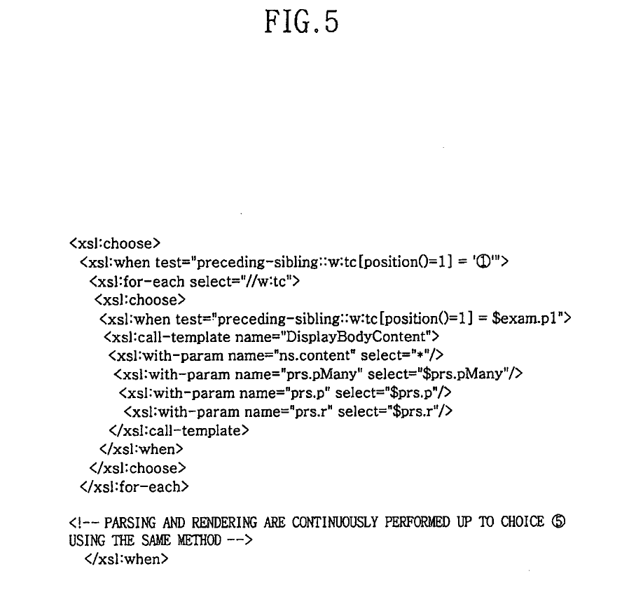

For example, the content (that is, xml_to_html.xsl) of eXtensible Style Language (XSL) for converting XML format into HTML format is shown in FIG. 5.

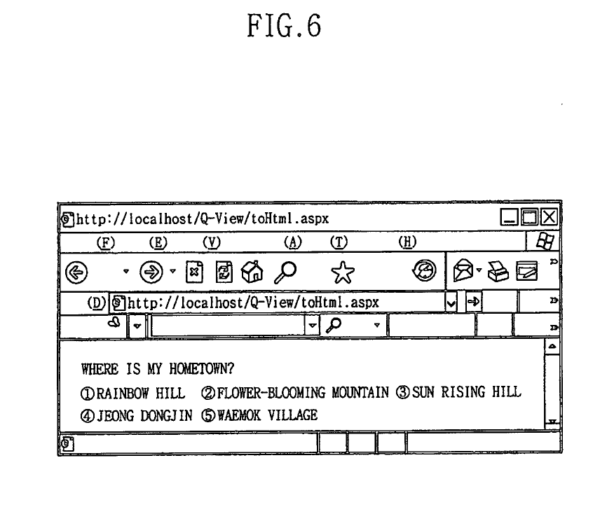

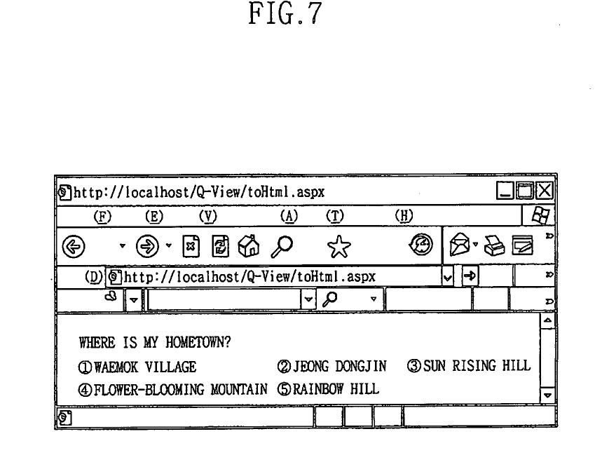

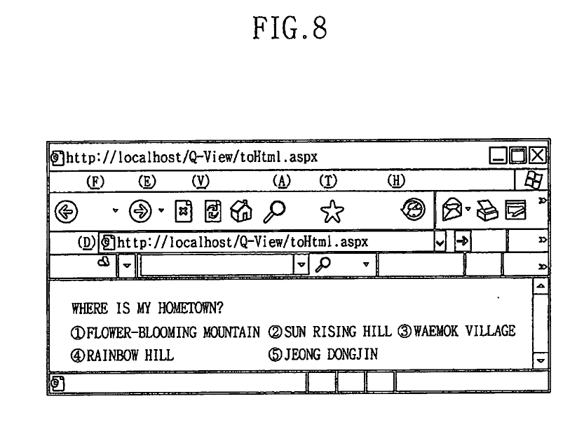

Further, results, obtained after the shuffling of choices has been performed, can be viewed through the web browser. The original form of a question, in which answer choices are not shuffled, is shown in FIG. 6. The case where the shuffling of answer choices is performed in the sequence of 5-4-3-2-1 based on the original form is shown in FIG. 7. The case where the shuffling of answer choices is performed in the sequence of 2-3-5-1-4 based on the original form is shown in FIG. 8. As shown in FIGS. 6 to 8, a test question is provided to respective testees, with the arrangement of answer choices being changed for the same question, thus preventing the occurrence of cheating between the testees.

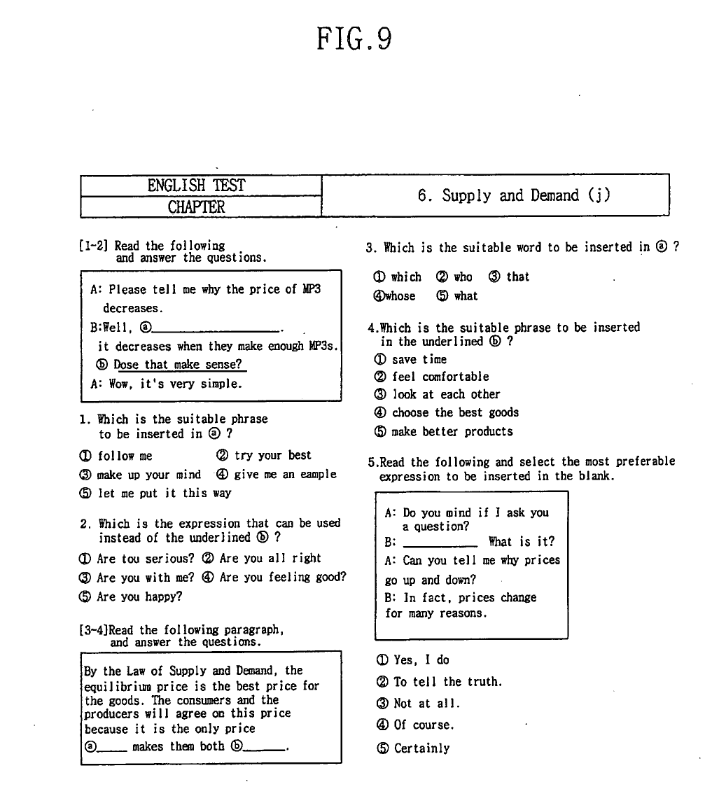

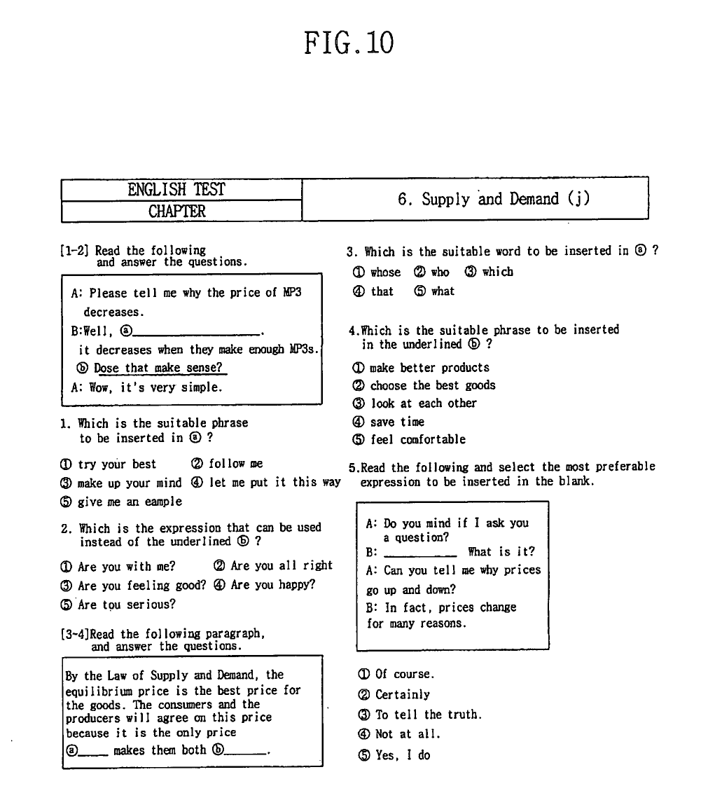

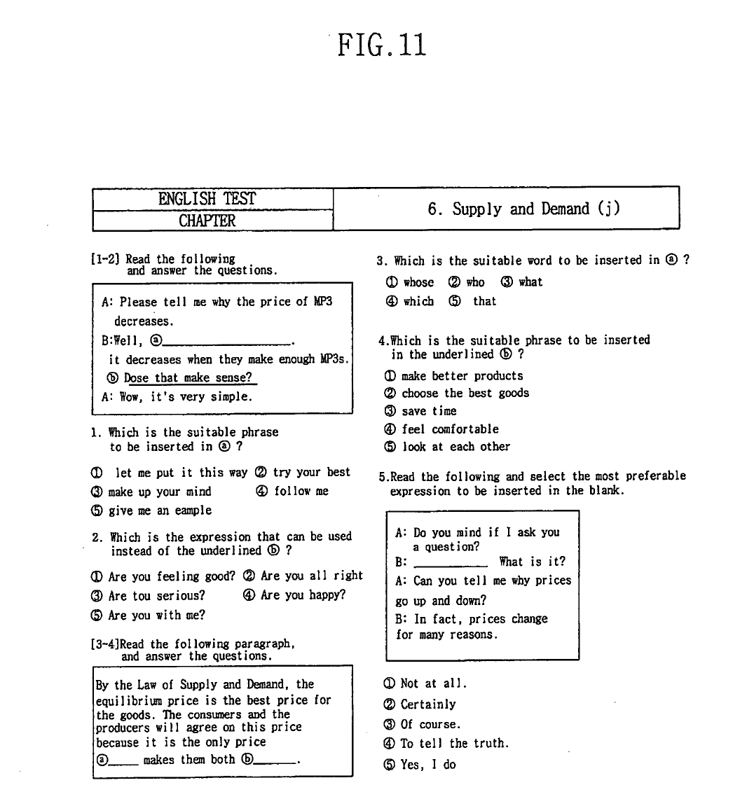

That is, referring to FIGS. 9 to 11, the above description can be more clearly seen. FIGS. 9 to 11 illustrate the types of test questions used when three members are provided with the same questions for a subject of a language research area and take an online test.

When three members simultaneously take the test, the questions presented to the three members are arranged in the same sequence, but the arrangement of answer choices dependent on the questions of each member has been shuffled. In FIGS. 9 to 11, only the arrangement of answer choices for questions is shuffled, but it is possible for both the sequence of questions and the arrangement of answer choices for the questions to be shuffled.

The test question types of FIGS. 9 to 11 are presented to online members who take a test using the HTML documents output from the HTML conversion unit 18b. If the test question types of FIGS. 9 to 11 must be provided to a great number of offline testees, the documents for a word processor, output from the DOC conversion unit 18a, are transmitted to the POD system 22, and test sheets, printed by the POD system 22, are provided to the testees at the same time on the same date.

The control unit 20 controls the storing operation in the database 14 depending on whether questions and meta information dependent thereon are received from a question master, and performs a control operation to operate the correct answer arrangement generating unit 16 and the second conversion unit 18 if a request for test sheets is received from a member through a communication network, such as the Internet, or from an offline test sheet orderer.

Further, the control unit 20 stores in advance information required for member authentication. Of course, the member authentication information may be stored in the second storage unit 14b.

Further, the control unit 20 occasionally provides basic information (a subject, the number of testees, the number of questions, etc.) so as to allow the correct answer arrangement generating unit 16 to generate the correct answer arrangement information of FIG. 4, or occasionally receives correct answer arrangement information, generated by the correct answer arrangement creation unit 16, from the correct answer arrangement generating unit 16, and temporarily stores the correct answer arrangement information so as to monitor whether a conversion operation is normally performed by the second conversion unit 18, based on the correct answer arrangement information.

For reference, in FIG. 1, only the single POD system 22 is shown, but a plurality of POD systems can be constructed according to circumstances.

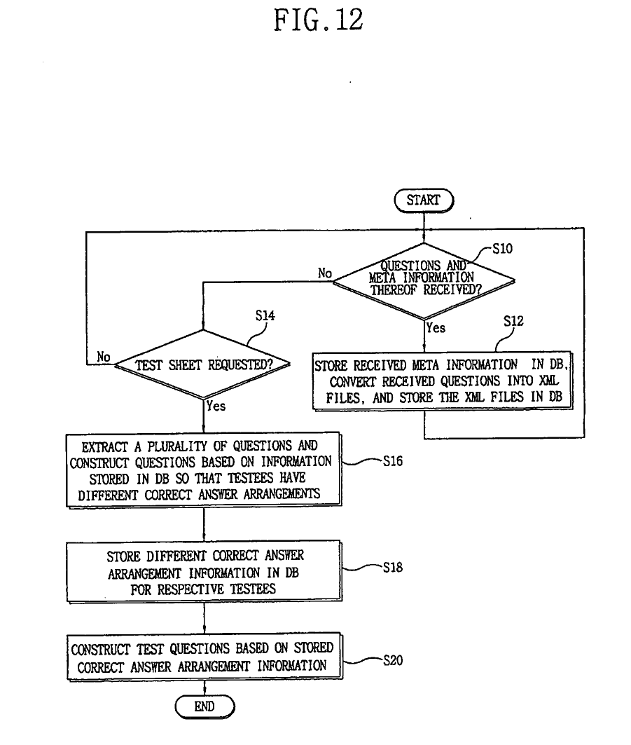

Now, a test question constructing method according to an embodiment of the present invention is described with reference to FIGS. 12 to 14.

First, the control unit 20 determines whether questions and meta information, containing the attributes thereof, that are received from the receiving unit 10, exist.

As a result of the determination, if the questions (generated using a word processor) and meta information dependent on the questions, received from the receiving unit 10, are found to exist (the case of “Yes” at step S10), the control unit 20 stores the meta information dependent on the corresponding questions, received from the receiving unit 10, in the second storage unit 14b of the database 14, and directs the XML conversion unit 12 to perform XML conversion.

Accordingly, the XML conversion unit 12 receives the questions provided by the receiving unit 10, converts the questions into XML format, and stores the content and composition information of the corresponding questions in the first storage unit 14a of the database 14 at step S12.

If questions and meta information dependent thereon are continuously received, the control unit 20 performs a control operation so that the storing operation in the database 14 is performed.

If test sheet request information has been input online or offline while no question and meta information is being input any more (the case of “Yes” at step S14), the control unit 20 provides basic information (a subject, the number of testees, the number of questions, etc.) required to generate the arrangement of correct answers while directing the correct answer arrangement generating unit 16 to generate the correct answer arrangement.

Accordingly, the correct answer arrangement generating unit 16 constructs a certain number of questions for a specific subject and answer choices therefor using a data file and meta information stored in the database 14, and varies the arrangement of correct answers to the constructed questions several times depending on a predetermined degree of shuffling so that testees have different correct answer arrangements (for example, the arrangement of answer choices for each question is shuffled with a degree of shuffling of 3 or more), thus allowing correct answer arrangements to differ between the testees at step S16.

Further, the correct answer arrangement generating unit 16 stores the created correct answer arrangement information for respective testees (refer to FIG. 4) in the second storage unit 14b at step S18, and transmits the correct answer arrangement information for respective testees to the control unit 20 while notifying the control unit 20 of the storage of the correct answer arrangement information.

Thereafter, the control unit 20 controls the second conversion unit 18 so that a conversion operation is performed.

That is, the DOC conversion unit 18a controls the control unit 20 to read the data file from the database 14 and convert the data file into a document for a word processor so that answer choices for each question are differently shuffled to cause respective testees to receive test sheets having different correct answer arrangements, based on the meta information of the corresponding data file.

Through this method, the DOC conversion unit 18a fabricates test sheets according to the number of testees at step S20. Respective testees receive the same test questions, but encounter test questions having different correct answer arrangements. The test questions output from the DOC conversion unit 18a are transmitted to the offline POD system 22, and are printed on test sheets and distributed to the testees.

Meanwhile, the HTML conversion unit 18b reads the data file from the database 14 and converts the read data file into an HTML document under the control of the control unit 20 so that answer choices for each question are differently shuffled to allow respective testees to take test sheets having different correct answer arrangements, based on the meta information of the corresponding data file.

Through the above method, the HTML conversion unit 18b fabricates test sheets according to the number of testees at step S20. Respective testees take the same test questions, but encounter test questions having different correct answer arrangements online. The test questions output from the HTML conversion unit 18b are displayed online on the screens of the terminals of the testees.

The DOC conversion unit 18a and the HTML conversion unit 18b do not always operate simultaneously, but are operated so that, if test questions are provided to the offline POD system 22 and test sheets are required to be printed, the test questions are ultimately transmitted to the POD system 22 only through the DOC conversion unit 18a, whereas if online members request the test questions, the test questions are ultimately transmitted to the corresponding members only through the HTML conversion unit 18b.

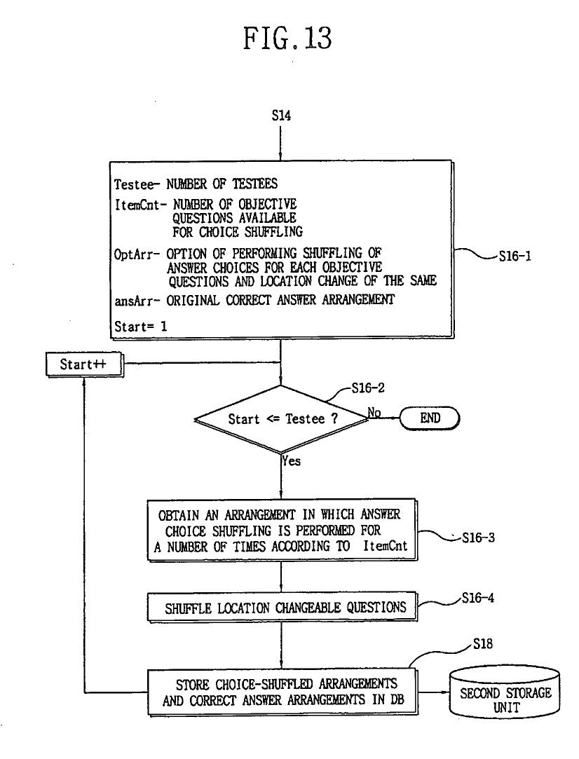

In the above description, a procedure of generating and storing correct answer arrangements is described in detail with reference to the flowchart of FIG. 13. Since an operator, operating the apparatus of the present invention, can select required test questions and the number of test questions for each subject at any time, the operator can predetermine test questions and the number of test questions for each subject or within the test range of each subject, and can preset the arrangement of original correct answers to the predetermined test questions.

In order to create variable correct answer arrangements according to the number of testees, the correct answer arrangement generating unit 16 starts to perform the operation of generating correct answer arrangements after parameters, such as the number of testees Testee, the number of questions ItemCnt, in which answer choices can be shuffled, of objective test questions, an option OptArr of performing the shuffling of answer choices for each question and the location change of each question, original correct answer arrangement ansArr, etc. are preset at step S16-1.

Upon initial operation, the correct answer arrangement generating unit 16 compares the number of testees Testee (for example, it is assumed to be 10) with a comparative value Start (for example, 1). The comparison operation may be performed by the control unit 20. Initially, since the comparative value Start is less than the number of testees at step S16-2, the correct answer arrangement generating unit 16 obtains an arrangement, in which the shuffling of choices for questions is performed a number of times according to the number of objective questions ItemCnt available for answer choice shuffling, from selected test questions (that is, the data file) at step S16-3.

Thereafter, the correct answer arrangement creation unit 16 performs shuffling on respective location changeable questions, based on the option OptArr of performing the shuffling of choices for each question and the location change of each question at step S16-4.

The choice-shuffled arrangement and the correct answer arrangement (that is, the arrangement of correct answers to test questions provided to a first testee) are stored in the second storage unit 14b at step S18. Thereafter, the previous comparative value is increased by 1, and the process returns to step S16-2 to repeat the operations starting from step S16-2. Such an operation terminates if the number of testees Testee becomes equal to or greater than the comparative value Start.

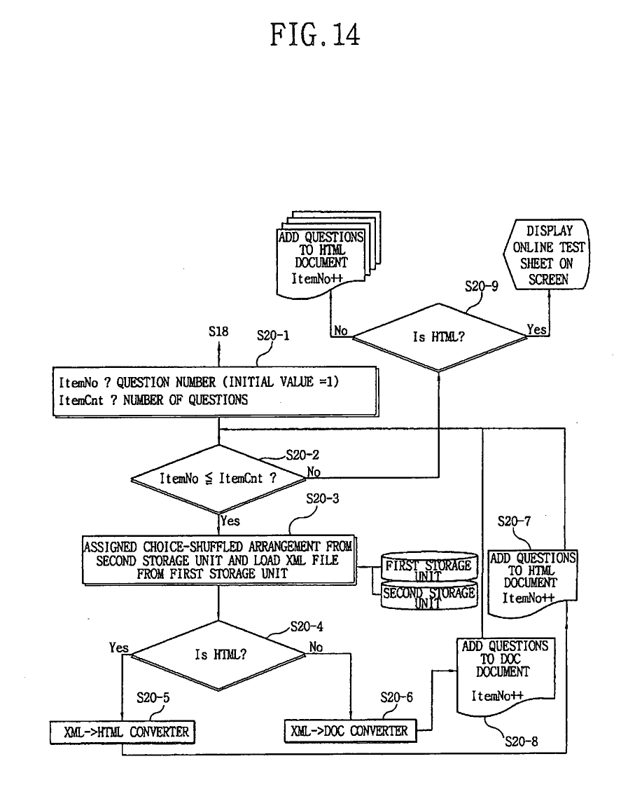

Further, in the description of FIG. 12, a procedure of constructing test questions based on the correct answer arrangement is described in detail with reference to the flowchart of FIG. 14. ItemNo is set to a question number (initial value=1), and ItemCnt is set to the number of questions based on correct answer arrangement at step S20-1.

Upon initial operation, the second conversion unit 18 compares the question number ItemNo with the number of questions ItemCnt (for example, it is assumed to be 10). The comparison operation may be performed by the control unit 20.

Initially, since the question number ItemNo is less than the number of questions ItemCnt at step S20-2, the second conversion unit 18 is assigned a answer choice-shuffled arrangement by the second storage unit 14b, and loads a data file (XML format) corresponding to the first question number at step S20-3.

Thereafter, if the currently loaded data file must be converted into an HTML document (the case of “Yes” at step S204), the HTML conversion unit 18b of the second conversion unit 18 is operated at step S20-5, and the conversion results are added to the HTML document as a question at step S20-7.

In contrast, if the loaded data file must be converted into a document for a word processor (the case of “No” at step S20-4), the DOC conversion unit 18a of the second conversion unit 18 is operated at step S20-6, and the conversion results are added to the document for a word processor as a question at step S20-8. In this case, whether to convert the loaded data into an HTML document or a document for a word processor is directed by the control unit 20.

If a single question is added in this way, the previous question number ItemNo is increased by 1, and then step S20-2 is again performed to continue the above operation.

During the operation, if the question number ItemNo becomes greater than the number of questions ItemCnt, a document conversion operation is not performed any longer, and test questions, which have been constructed through the conversion operation, are output.

That is, if the test questions must be output online (the case of “yes” at step S20-9), the constructed test questions are fabricated in the form of test sheets, and are displayed on the screen of the terminals of respective online testees. In contrast, if the test questions must be output offline (the case of “No” at step S20-9), the constructed test questions are transmitted to the POD system 22, and are printed on test sheets by the POD system 22.

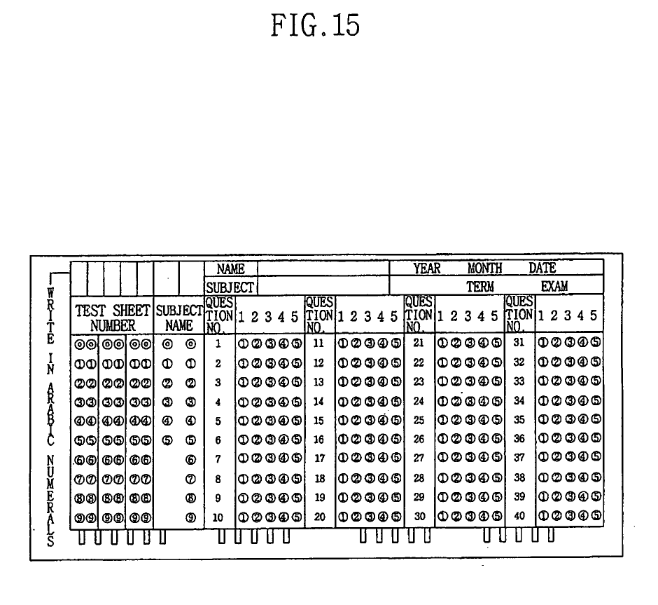

Meanwhile, members taking an online test, or testees taking an offline test fill out answers on an OMR card, as shown in FIG. 15. Of course, the members taking an online test may input answers using the input means of his or her terminal. The test sheet numbers of FIG. 15 are considered to be identical to those of FIG. 4. For example, the test sheet numbers are issued with different consecutive numbers ranging from 0 to 999999 corresponding to a million persons with respect to each subject.

In the above embodiments of the present invention, a document for a word processor has been exemplified as the form of a document that can be easily generated, edited or printed on paper, and an HTML document has been exemplified as the form of a document that can be easily displayed online, but it is apparent that an embodiment of converting test questions into other forms or types of documents and providing the documents can be easily implemented.

Meanwhile, the present invention is not limited to the above embodiments, but various modifications, additions and substitutions are possible, without departing from the scope and spirit of the invention. The technical spirit of the modifications, additions and substitutions must also be considered to belong within the scope of the accompanying claims.

1. A test question constructing apparatus, comprising:
a receiving unit for receiving a plurality of questions and meta information, containing attributes thereof, through a network;
a first conversion unit for converting the received questions into data files, containing content and composition information;
a database for storing therein the meta information of the received questions and the data files;
a correct answer arrangement generation unit for varying arrangement of respective answer choices for test questions to be equally provided to testees using the data files and the meta information stored in the database, depending on a preset degree of shuffling, thus generating different correct answer arrangements for respective testees; and
a second conversion unit for extracting a plurality of data files stored in the database and converting the data files into a format available for a test so that test questions having different correct answer arrangements for respective testees are output, based on correct answer arrangement information generated by the correct answer arrangement generating unit.

2. The test question constructing apparatus according to claim 1, wherein the meta information contains a correct answer to each question, information indicating whether shuffling of answer choices for the question is possible, a subject to which the question belongs, and an identification (ID) of the question.

3. The test question constructing apparatus according to claim 1 or 2, wherein the correct answer arrangement information contains a subject code, a test sheet ID of the subject code, a test sheet number for each testee belonging to the test sheet ID, and correct answers to questions, in which answer choices have been differently shuffled for respective test sheet numbers.

4. The test question constructing apparatus according to claim 1, wherein the second conversion unit comprises a first converter for converting the plurality of data files into respective documents for a word processor, and a second converter for converting the data files into respective documents having a format for online display.

5. The test question constructing apparatus according to claim 4, wherein the documents for a word processor, output from the first converter, are transmitted to a Print-on-Demand (POD) system.

6. The test question constructing apparatus according to claim 4, wherein the documents having format for online display, output from the second converter, are displayed on screens of terminals of the testees through web browsers.

7. A test question constructing method, comprising:
a first step of receiving a plurality of questions and meta information, containing attributes thereof, through a network;
a second step of converting the received questions into data files, containing content and composition information;
a third step of storing the meta information of the received questions and the data files in a database;
a fourth step of varying arrangement of respective answer choices for test questions to be equally provided to testees using the data files and the meta information stored in the database, depending on a preset degree of shuffling, thus generating different correct answer arrangements for respective testees; and
a fifth step of extracting a plurality of data files stored in the database and converting the data files into a format available for a test so that test questions having different correct answer arrangements for respective testees are output, based on correct answer arrangement information generated at the fourth step.

8. The test question constructing method according to claim 7, wherein the meta information contains a correct answer to each question, information indicating whether shuffling of answer choices for the question is possible, a subject to which the question belongs, and an identification (D) of the question.

9. The test question constructing method according to claim 7, wherein the correct answer arrangement information contains a subject code, a test sheet ID of the subject code, a test sheet number for each testee belonging to the test sheet ID, and correct answers to questions, in which answer choices have been differently shuffled for respective test sheet numbers.

10. The test question constructing method according to claim 7, wherein the fifth step is performed so that, if test questions are provided to offline testees, the data files are converted into respective documents for a word processor, whereas if test questions are provided to online testees, the data files are converted into respective documents having a format for online display.

11. The test question constructing method according to claim 10, wherein the test questions converted into the documents for a word processor are transmitted to a Print-on-Demand (POD) system.

12. The test question constructing method according to claim 10, wherein the test questions, converted into documents having a format for online display, are displayed on screens of terminals of the testees through Web browsers.

13. A test sheet fabricated using the test question constructing method disclosed in claim 7.

14. A test sheet fabricated using the test question constructing method disclosed in claim 8.

15. A test sheet fabricated using the test question constructing method disclosed in claim 9.

16. A test sheet fabricated using the test question constructing method disclosed in claim 10.

17. A test sheet fabricated using the test question constructing method disclosed in claim 11.

18. A test sheet fabricated using the test question constructing method disclosed in claim 12.

19. A computer-readable recording medium storing a test question constructing program for executing the test question constructing method disclosed in claim 7.

20. A computer-readable recording medium storing a test question constructing program for executing the test question constructing method disclosed in claim 8.

21. A computer-readable recording medium storing a test question constructing program for executing the test question constructing method disclosed in claim 9.

22. A computer-readable recording medium storing a test question constructing program for executing the test question constructing method disclosed in claim 10.

23. A computer-readable recording medium storing a test question constructing program for executing the test question constructing method disclosed in claim 11.

24. A computer-readable recording medium storing a test question constructing program for executing the test question constructing method disclosed in claim 12.
